(19) United States
(12) Patent Application Publication
(10) Pub. No.: US 2013/0096993 A1
(43) Pub. Date: Apr. 18, 2013

(54) METHOD OF TOLLING VEHICLES IN AN OPEN-ROAD TOLL SYSTEM

(71) Applicants: Adam Boszormenyi, Zurndorf (AT); Clemens Novak, Wien (AT); Bernhard Groiss, Wien (AT)

(72) Inventors: Adam Boszormenyi, Zurndorf (AT); Clemens Novak, Wien (AT); Bernhard Groiss, Wien (AT)

(73) Assignee: KAPSCH TRAFFICCOM AG, Wien (AT)

(21) Appl. No.: 13/598,041

(22) Filed: Aug. 29, 2012

(30) Foreign Application Priority Data
Oct. 12, 2011 (EP) 11 450 132.3

(51) Int. Cl. G07B 15/06

(52) U.S. Cl. 705/13

(57) ABSTRACT

A method of tolling vehicles in an open-road toll system with vehicle-based on-board units and roadside radio beacons. The method includes transmitting transaction information and a factor from the on-board unit; updating the factor as a function of the transmitted transaction information and calculating a debit amount as a function of the updated factor; transmitting a debit request with the calculated debit amount and the updated factor to the on-board unit; and debiting the received debit amount to a toll credit account in the on-board unit and writing a new transaction information concerning this new debit transaction and the received updated factor into the on-board unit.

### CROSS-REFERENCE TO RELATED APPLICATION(S)

This application claims priority to European Patent Application No. 11 450 132.3, filed on Oct. 12, 2011, the entire contents of which are hereby expressly incorporated by reference.

### FIELD OF THE INVENTION

The present invention relates to a method of tolling vehicles in an open-road toll system with vehicle-based on-board units that are able to communicate with roadside radio beacons via short-range radio interfaces.

### BACKGROUND

Some on-board units comprise a memory for an electronic toll credit account and with the radio beacons sending requests for debiting the toll credit account with a debit amount to passing on-board units. On-board units (OBUs) of this type are also known as “prepaid OBUs” and, similar to an “electronic wallet,” carry a toll credit account (balance) from which, radio beacons that act as toll stations can directly charge toll fees to the passing vehicles. In so-called “open” road toll systems, each radio beacon, acting as a stand-alone unit, collects a toll from the passing vehicle solely for the road segment in which the radio beacon is located, e.g., a “toll plaza.” The radio beacons are not in communication with one another and the data they generate are transmitted with a relatively long delay time to a central system solely for control purposes. The transmission of data from one beacon to another within a specifically defined time window would entail a high degree of technical complexity and would be associated with high implementation costs. Thus, open-road toll systems have no “memory”, that is, a toll beacon has no information about the previous route taken by a vehicle within the toll road system. This makes a beacon-traversing calculation of toll fees impossible.

### SUMMARY

The present invention overcomes this disadvantage by a method of tolling vehicles in an open-road toll system, which makes possible a dynamic, beacon-traversing and real-time calculation of the toll fees. The present invention is a method of tolling vehicles with on-board units which can communicate with roadside radio beacons via short-range radio interfaces, with the on-board units comprising a first memory for an electronic toll credit account, a second memory for a transaction information concerning a last debit to the toll credit account, and a third memory for a variable factor, and with the radio beacons sending requests for debiting a toll credit account with a debit amount to passing on-board units, which method is executed on one or more electronic devices, as an on-board unit passes a toll beacon. The method includes retrieving the transaction information from the second memory and the factor from the third memory of the on-board unit via the radio interface into the toll beacon; updating the factor as a function of the retrieved transaction information and calculating a debit amount as a function of the updated factor in the toll beacon; transmitting a debit request with the calculated debit amount and the updated factor from the toll beacon via the radio interface to the on-board unit; and debiting the transmitted debit amount to the toll credit account in the first memory as a new debit transaction, storing a new transaction information concerning said new debit transaction in the second memory, and storing the received updated factor in the third memory of the on-board unit.

According to some embodiments of the present invention, the toll credit account may be debited with the debit amount in the toll beacon, when the toll beacon first reads out the toll credit account from the on-board unit and when subsequently the toll credit account that has been reduced by the debit amount and has thus been updated is written back into the first memory of the on-board unit.

The transaction information, which is transported in the second memory and which is used to update the factor, may contain the location, the time, the debit amount and/or simply only information about one or a plurality of the last debit transactions; the factor can be updated as a function of one or a plurality of these data. Thus, for example, each time the factor is updated, it can be reduced to, or by, a fraction of its previous value if the transaction information displays a passage past a previous beacon with a certain (minimum) debit amount, a passage past a previous beacon within a specified time window and/or a passage past a previous beacon within a certain local area.

During updating, the factor may be reduced if the read-out location or the read-out time is within predefined limits, before the current location or before the current time of the radio beacon. In some embodiments, during updating, the factor is again increased or reset to its original value if the read-out location or the read-out time is outside such predefined limits. This makes it possible, e.g., for an uninterrupted trip past a plurality of toll beacons to be rewarded with continuously decreasing debit amounts, whereas interrupted trips lead to a new start, i.e., the resetting of the factor and thus of the debit amount to an initial value.

As an alternative, the reverse may occur, that is, the factor can be increased in the first case mentioned above and it can be decreased or reset in the second case mentioned, thereby making it possible to implement traffic policy measures to control the flow of traffic.

### BRIEF DESCRIPTION OF THE DRAWINGS

The invention will be explained in greater detail based on a practical example that is illustrated in the enclosed drawings. As can be seen from the drawings:

FIG. 1 shows a diagrammatic perspective view of an open-road toll system in which the method according to the present invention is executed;

FIG. 2 shows a block diagram of one of the on-board units of the toll road system of FIG. 1;

FIG. 3 shows a flow chart of the method according to the present invention; and

FIG. 4 shows a flow chart of an alternative embodiment of the method according to the present invention.

### DETAILED DESCRIPTION

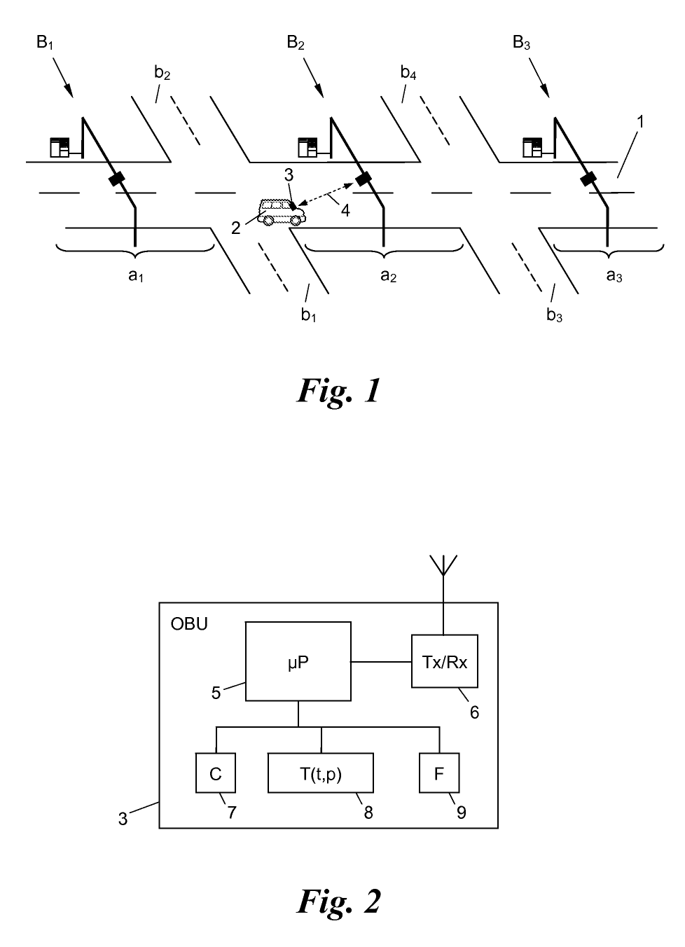

FIG. 1 shows a toll road system of the so-called “open” type in which toll stations in the form of radio beacons B₁, B₂, B₃ . . . , collectively referred to as Bᵢ, are located along toll road segments a₁, a₂, a₃ . . . , collectively referred to as aᵢ, of a toll road 1 so as to collect toll fees (“to toll”) for the use of the toll road 1 by vehicles 2. Between the road segments aᵢ, there are access and exit roads or toll-free road segments b₁, b₂, . . . , collectively referred to as bᵢ, where vehicles can enter or exit. Thus, each radio beacon Bᵢ collects a toll only for the passage of a vehicle passing its associated road segment aᵢ, which is the characteristic feature of an open-road toll system.

The vehicles 2 are each equipped with an on-board unit (OBU) 3 which is able to wirelessly communicate via a short-range radio interface 4, e.g., based on the dedicated short-range communication (DSRC), wireless local area network (WLAN) or wireless access in a vehicle environment (WAVE) standard, with a radio beacon Bᵢ, as the on-board unit passes this radio beacon. As part of a wireless communication via the radio interface 4, each radio beacon Bᵢ sends a debit request to a passing on-board unit 3, which causes this on-board unit to debit a specific amount to an “electronic wallet” that is contained in the on-board unit 3. The wireless coverage range of a radio beacon Bᵢ, and thus the range of the radio interface 4, is limited to a few meters to several tens of meters around the range of a radio beacon Bᵢ. This makes it possible, at a successful wireless communication between the on-board unit 3 and the radio beacon Bᵢ, to pinpoint a vehicle 2 to the location of the radio beacon Bᵢ, and thus to the road segment aᵢ of this radio beacon, so as to collect a toll for the use of this segment.

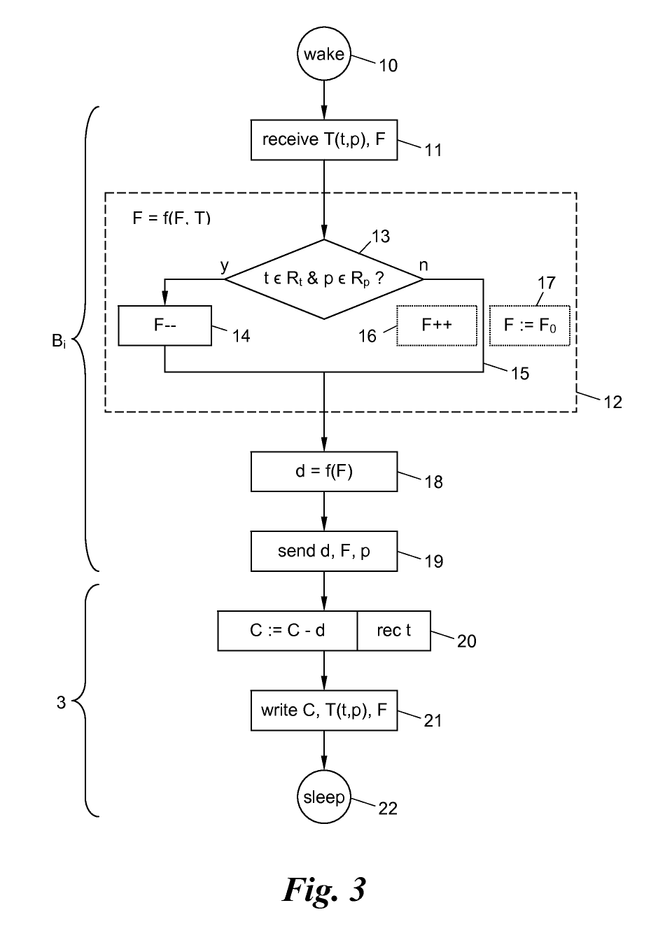

FIG. 2 shows an exemplary diagram of an on-board unit 3 for this particular purpose. The on-board unit 3 comprises a control unit 5, e.g., a microprocessor, which communicates with a transceiver 6 to create the radio interface 4 to a radio beacon Bᵢ. The control unit 5 is also connected to a first memory 7 which carries an electronic toll credit account C (“credit balance”), to which toll fees d can be continuously debited whenever a radio beacon Bᵢ sends a relevant debit request (“toll transaction”), as will be described below with reference to FIG. 3.

In addition, the on-board unit 3 contains a second memory 8 for receiving a transaction information T concerning the latest debit transaction. In the simplest case, the transaction information T can be Boolean information affirming that a debit to the account has (in fact) been made; the amount of the toll fee d last debited to the toll credit account C; the time t of the last debit transaction or debit request; and/or the location p of the last debit transaction, which may simply be the identification code of the beacon Bᵢ that sent the last debit request since the locations of the beacons Bᵢ in the toll road system are known. In the example illustrated, the transaction information T comprises the time t and the location p of the last debit made to the toll credit account C in the memory 7. It is also possible to store more than one transaction information T in the memory 8, e.g., concerning a plurality of debit transactions last processed.

The on-board unit 3 also comprises a third memory 9 in which a factor F for calculating the debit amounts d in the toll beacons Bᵢ is stored, as will be explained in greater detail below.

The method according to the present invention creates a “memory” for the route taken by a vehicle past a plurality of toll beacons of an open-road toll system in that each on-board unit separately transmits information about its previous route in the form of a factor that is stored in the on-board unit and updated each time the vehicle passes a beacon. This continuously updated factor can subsequently be used, for example as a discount factor and to reward trips past a plurality of radio beacons, i.e., covering a longer stretch in the road toll system, when this factor is continuously reduced each time the vehicle passes a beacon. The factor can also be used, to punish when the factor is continuously increased each time the vehicle passes a beacon.

FIG. 3 shows a flow chart of the method, which is processed between the on-board unit 3 and a radio beacon Bᵢ whenever an on-board unit 3 passes a radio beacon Bᵢ. In an initialization step 10, wireless communication is initiated on the radio interface 4 when an on-board unit 3 enters the radio coverage range of a radio beacon Bᵢ. The initialization step 10 comprises waking up the on-board unit 3 from a low-current standby mode and exchanging several data packets for mutual identification, for example, in the DSRC standard, a “Beacon Service Table” (BST) message from the radio beacon Bᵢ to the on-board unit 3 and a “Vehicle Service Table” (VST) message as a response from the on-board unit 3 to the radio beacon Bᵢ. In this step 10, the current time t and the current location p, e.g., referenced as the identification of the radio beacon Bᵢ, can be communicated to the on-board unit 3; however, this information can also be communicated later, as will be described below.

After the initialization, the transaction information T in a first step 11 is read out from the second memory 8 and the factor F is read out from the third memory 9 of the on-board unit 3 and placed into the radio beacon Bᵢ via the radio interface 4. In the example illustrated, the transaction information T is the time t and the location p of the last debit transaction made by a preceding radio beacon Bᵢ₋₁ to the toll credit account C.

In a next step 12, the factor F is updated as a function of the read-out transaction information T; i.e.,

F=f(F,T). (1)

In some embodiments, a decision-making step 13 is used to check whether the read-out time t is within the predefined limits Rₜ and whether the read-out location p is within the predefined limits Rₚ. The time limits Rₜ allowed can be, for example, one hour or one day. Thus, only if the last debit transaction does not date back more than one hour or one day, the time condition “t∈Rₜ?” is met. The location limits Rₚ can be, for example, a local area immediately around a beacon Bᵢ₋₁ which, in the direction of travel, is located upstream, that is, the location condition “p∈Rₚ?” is met only if the last debit transaction occurred in the immediately preceding beacon Bᵢ₋₁.

If both conditions in step 13 are met (branch “y”), the factor F is reduced. For example, it is decremented by a fraction (F:=F−0.1), or decremented to a fraction (F:=F−0.9), in step 14.

If test 13 is negative (branch “n”), the factor F is maintained constant (route 15) or is increased. For example, it is incremented by, or to, a fraction (F:=F+0.1 or preferably F:=F÷0.9), in step 16. Another alternative is to reset the factor F to an initial value F₀, e.g., to F:=1.0, in step 17.

In some embodiments, the factor F in step 12 can also be updated in a different way as a function of the transaction information T, as discussed earlier.

In some embodiments, the factor F can also be increased in step 14 and decreased in step 16, e.g., if the debit amount d is to be increased as a function of the stretch of road driven to control the flow of traffic.

In step 18, the debit amount d is subsequently calculated as a function of the updated factor F as:

d=f(F′) (2),

for example, as d=d₀·F, where d₀ is a predefined debit amount charged for the use of the road segment aᵢ, e.g., 1 Euro.

In step 19, the debit request (“send d”) sent by the radio beacon B, to the on-board unit 3 is complemented by the updated factor F and, optionally, the location p of the beacon Bᵢ, is sent to the onboard unit 3. The location may be referenced as the radio beacon identification if the transaction information T uses this location p and if this location has not already been sent earlier, e.g., in the initialization step 10, to the on-board unit 3.

In step 20, the on-board unit 3 is now able to debit the debit amount d received by toll credit account C from the first memory 7 as:

C:=C−d (3).

The on-board unit also records the current time t, unless this time has already been communicated by the radio beacon Bᵢ, if the transaction information T is intended to also comprise the time t of the debit transaction.

In step 21, the updated toll credit account C is subsequently written into the first memory 7, the transaction information T (in this case comprising the debit time t and the location p at which the debit was made) is written into the second memory 8, and the factor F updated by the radio beacon B, is written into the third memory 9. Subsequently, the on-board unit 3 returns to its standby mode until it passes the next beacon (step 22).

During the passage past the next beacon, e.g., at the radio beacon Bᵢ₊₁, the factor F is again read out in step 11 and again updated so that in this manner continuously reduced debit amounts dᵢ result, for example, as:

$$\begin{matrix}{d}_{1} = d \cdot {F}_{0} \\ {d}_{2} = d \cdot {F}_{0} \cdot 0.9 \\ {d}_{3} = d \cdot {F}_{0} \cdot 0.9 \cdot 0.9 \\ ⋮\end{matrix} \qquad ( 4 )$$

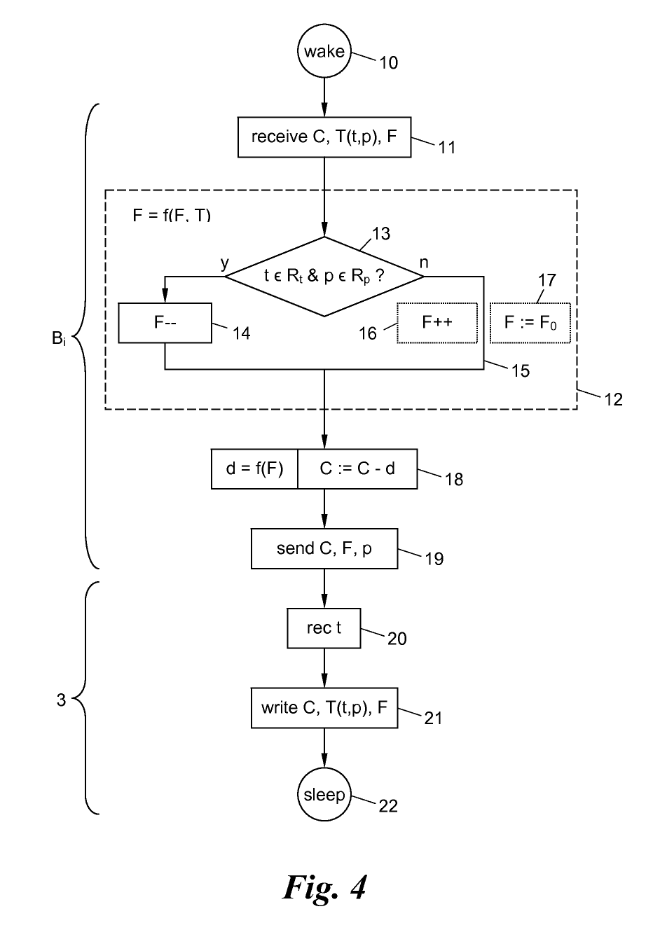

In some embodiments of the method, the debit amount d can also be debited to the toll credit account C in the radio beacon B. As illustrated in FIG. 4, in step 11, the toll credit account C can also be read out from the first memory 7 of the on-board unit 3. In step 18, the read-out toll credit account C is reduced in the radio beacon Bᵢ by the calculated debit amount d (C:=C−d); in step 19, the updated toll credit account C instead of the toll debit amount d is sent to the on-board unit 3; in step 20, no debit occurs; and in step 21, the updated toll credit account C is written back into the first memory 7 of the on-board unit 3.

It will be recognized by those skilled in the art that various modifications may be made to the illustrated and other embodiments of the invention described above, without departing from the broad inventive step thereof It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method of tolling vehicles in an open-road toll system with vehicle-based on-board units that are able to communicate with roadside radio beacons via short-range radio interfaces, the on-board units comprising a first memory for an electronic toll credit account, a second memory for a transaction information concerning a last debit to the toll credit account, and a third memory for a variable factor, and the radio beacons sending requests for debiting a debit amount to the toll credit account to passing on-board units, the method comprising the following steps that are carried out as an on-board unit passes a toll beacon:
retrieving the transaction information from the second memory and the factor from the third memory of the on-board unit via the radio interface into the toll beacon;
updating the factor as a function of the retrieved transaction information and calculating a debit amount as a function of the updated factor in the toll beacon;
transmitting a debit request with the calculated debit amount and the updated factor from the toll beacon via the radio interface to the on-board unit; and
debiting the transmitted debit amount to the toll credit account in the first memory as a new debit transaction, storing a new transaction information concerning said new debit transaction in the second memory, and storing the received updated factor in the third memory of the on-board unit.

2. The method as in claim 1, wherein the transaction information comprises the location of the radio beacon that has transmitted the debit request.

3. The method as in claim 1, wherein the transaction information comprises the time of the debit transaction.

4. The method as in claim 2, wherein the transaction information comprises the time of the debit transaction.

5. The method as in claim 4, wherein during updating, the factor is reduced when the retrieved location and the retrieved time are within predefined limits, before the current location and the current time of the radio beacon.

6. The method as in claim 5, wherein during updating, the factor is increased or reset to a predefined value when the retrieved location or the retrieved time is outside the predefined limits.

7. The method as in claim 4, wherein during updating, the factor is increased when the retrieved location and the retrieved time are within predefined limits, before the current location and the current time of the radio beacon.

8. The method as in claim 7, wherein during updating, the factor is decreased or reset to a predefined value when the retrieved location or the retrieved time is outside the predefined limits.

9. A method of tolling vehicles in an open-road toll system with vehicle-based on-board units that are able to communicate with roadside radio beacons via short-range radio interfaces, the on-board units comprising a first memory for an electronic toll credit account, a second memory for a transaction information concerning a last debit to the toll credit account, and a third memory for a variable factor, and the radio beacons sending requests for debiting a debit amount to the toll credit account to passing on-board units, the method comprising the following steps that are carried out as an on-board unit passes a toll beacon:
retrieving the toll credit account from the first memory, the transaction information from the second memory and the factor from the third memory of the on-board unit via the radio interface into the toll beacon;
updating the factor as a function of the retrieved transaction information, calculating a debit amount as a function of the updated factor, and debiting the debit amount to the retrieved toll credit account in the toll beacon;
transmitting the debited toll credit account and the updated factor from the toll beacon via the radio interface to the on-board unit; and
storing the transmitted toll credit account in the first memory as a new debit transaction, storing a new transaction information concerning said new debit transaction in the second memory, and storing the transmitted updated factor in the third memory of the on-board unit.

10. The method as in claim 9, wherein the transaction information comprises the location of the radio beacon that has transmitted the debit request.

11. The method as in claim 9, wherein the transaction information comprises the time of the debit transaction.

12. The method as in claim 10, wherein the transaction information comprises the time of the debit transaction.

13. The method as in claim 12, wherein during updating, the factor is reduced when the retrieved location and the retrieved time are within predefined limits before the current location and the current time of the radio beacon.

14. The method as in claim 13, wherein during updating, the factor is increased or reset to a predefined value when the retrieved location or the retrieved time is outside the predefined limits.

15. The method as in claim 12, wherein during updating, the factor is increased when the retrieved location and the retrieved time are within predefined limits before the current location and the current time of the radio beacon.

16. The method as in claim 15, wherein during updating, the factor is decreased or reset to a predefined value when the retrieved location or the retrieved time is outside the predefined limits.
